(19) United States
(12) Patent Application Publication
(10) Pub. No.: US 2025/0289740 A1
(43) Pub. Date: Sep. 18, 2025

(54) MEMBRANE BIOREACTOR MODULE

(71) Applicants: DUPONT SPECIALTY MATERIALS SINGAPORE PTE. LTD., Singapore (SG); DDP SPECIALTY ELECTRONIC MATERIALS US, LLC, Wilmington, DE (US)

(72) Inventors: Joseph LANGMAID, Midland, MI (US); Robert J. MCMAHON, South Windsor (AU)

(21) Appl. No.: 18/862,686

(22) PCT Filed: May 10, 2023
(86) PCT No.: PCT/US2023/021669

§ 371 Date: Nov. 4, 2024

Related U.S. Application Data
(60) Provisional application No. 63/341,241, filed on May 12, 2022.

(51) Int. Cl. C02F 3/12

(52) U.S. Cl. CPC C02F 3/1273; C02F 2201/004; C02F 2201/007; C02F 2203/006; C02F 2301/04

(57) ABSTRACT

The present invention provides a membrane bioreactor module including base and upper assemblies between which extend an array of fibre membranes, the module further including four corner supports or columns extending between the base and upper assemblies at least one of which defines an internal fluid pathway from the base assembly to the upper assembly to facilitate the removal of permeate from the base assembly.

### CROSS-REFERENCE TO RELATED APPLICATIONS

The present application claims priority under 35 U.S.C. § 365(c) to U.S. Provisional Appln. No. 63/341,241, filed on May 12, 2022, which is incorporated herein in its entirety.

### FIELD OF THE INVENTION

This invention relates to a membrane bioreactor module, and in particular a module which defines a novel fluid filtrate pathway and means for sealing upper and lower ends of the module to a body of the module.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

The use of membrane bioreactors (MBR) to effect filtration of wastewater and the like is well known. See, for example, Judd, Simon and Judd, Claire, Eds., The MBR Book, Elsevier Science (2006); and Water Environment Federation, Membrane Systems for Wastewater Treatment, McGraw Hill Professional (2005). Such MBR systems often consist of multiple fibre modules each of which includes a large array of hollow fibre membranes captured between a base and an upper assembly, via which the effluent to be treated can be drawn through the fibres to effect filtration. Racks of the modules are immersed in a main treatment tank and are therefore exposed to the wastewater or other effluent to be treated.

The microfibers are normally potted into the base and upper assemblies, with the upper and/or lower end of each microfiber communicating with a sealed interior space defined within the respective assembly. In this way fluid can be driven under a positive or negative pressure difference, for example via a pump or the like through the sidewall of the fibres from the main treatment tank, along the length of the fibre and into the base and/or upper assembly for onward treatment or extraction. This is often referred to as an “outside in” flow direction, with solid contaminants being deposited on the outside surface of the fibre membranes, which contaminants may be subsequently processed in a number of different ways. Such MBR systems may be a so called “single” or “dual” header system in which a lumen of each of the potted fibres communicates with the upper and/or lower assembly for permeate removal from the fibres. The term “lumen” as used herein refers to the bore of a tube-like structure, for example to the inner passage of a hollow fibre membrane. The fibre membranes may be formed of many different materials, commonly a hydrophilic polymer or polymer blend, such as PVDF. The fibre membranes are also manufactured to have a pore size appropriate for the particular filtering application.

Some MBR systems are operable to reverse the flow direction in order to flush the solid contaminants from the outer surface of the fibre membranes, following which the solids may be settled and removed for processing. Additionally or alternatively MBR systems may include some form of air scouring to remove contaminants from the outer surface of the fibre membranes for subsequent processing, such as sludge removal and drying. Additional upstream and/or downstream treatment steps will generally be implemented within the wastewater treatment plant.

Such MBR systems have numerous advantages, including consistent treated water quality and high rejection efficiency of organic constituents, solids and microorganisms. MBR systems generally have a relatively small footprint, do not normally require a clarifier tank or sand filter, and are modular in construction allowing for plant expansion as required. MBR systems do not encounter sludge “bulking” or settling issues, are generally able to handle sudden changes in flow, have a reduced sludge yield, are highly automatable and the operational energy costs are constantly reducing.

In an MBR the higher the density of fibres within each reactor, and thus each module, the greater the filtration capacity as the greater the membrane surface area available to remove solids and/or other contaminants. It is therefore beneficial to increase the fibre density for a given size or footprint of reactor module, whilst ensuring the reliability and longevity of the modules to ensure consistent treatment over prolonged operating periods, which is likely to be decades of operation in the case of municipal wastewater treatment plants, desalination plants, etc.

It is therefore an object of the present invention to provide a membrane bioreactor module having improved fibre density for a given module footprint while at the same time minimising design and manufacturing complexity in order to create a low cost and reliable component.

### SUMMARY OF THE INVENTION

Accordingly, provided herein is a membrane bioreactor module comprising a base assembly, an upper assembly, and an array of hollow fibre membranes extending therebetween; a plurality of support members extending between the base and upper assemblies, at least one of the support members being hollow such as to define a fluid flow path between the base and upper assemblies; wherein the upper assembly comprises an anchor plate having an upper face and a lower face and into which lower face one end of each of the support members is fixed via a lower face of the anchor plate; a plurality of couplings in the anchor plate each defining a socket open to the lower face and retaining an end of the respective hollow support member, and at least one duct extending laterally from the socket and opening onto the upper face.

Preferably, the anchor plate defines at least one enclosure filled with a potting resin securing the hollow fibre membranes to the anchor plate.

Preferably, each duct extends through the potting resin.

Preferably, each duct opens onto the upper face adjacent the respective fastener.

Preferably, the potting resin defines the upper face of the anchor plate.

Preferably, each duct is defined by an insert secured to the anchor plate.

Preferably, the socket is integrally formed with the anchor plate.

Preferably, the socket defines an open lower end, a closed upper end, and a lateral window from which the duct extends.

Preferably, the hollow support member is adhered into the socket.

Preferably, the hollow support member is adhered into the base assembly.

Preferably, the membrane bioreactor module comprises a manifold mounted to the upper face of the anchor plate for establishing fluid communication with the bioreactor module.

Preferably, each coupling comprises a fastener axially aligned with the socket and accessible at the upper face for securing the manifold to the anchor plate.

Preferably, the fastener comprises a threaded insert secured to the anchor plate and having a thread with a longitudinal axis co axial with a longitudinal axis of the support member and the socket.

Preferably, the manifold is secured, more preferably bolted, to the anchor plate.

Preferably, the manifold comprises a respective lug having a through aperture which overlies each fastener when the manifold is aligned against the upper face of the anchor plate.

Preferably, the membrane bioreactor module is substantially rectangular in cross section, four support members being provided, one at each corner.

Preferably, more than one of the support members is hollow and defines a respective fluid flow path between the base and upper assemblies.

Preferably, the manifold defines a fluid permeate conduit in fluid communication with the at least one duct, and a separate air supply conduit for delivering air to the base assembly.

Preferably, the membrane bioreactor module comprises a gasket captured between the manifold and the anchor plate.

Preferably, the base assembly comprises at least one enclosure filled with potting resin securing the hollow fibre membranes to the base assembly in a manner which permits fluid communication between a lumen of each fibre and a chamber of the base assembly.

Preferably, the membrane bioreactor module comprises an air scouring system mounted to the base assembly.

Preferably, the air scouring system is operable to generate pulsed release of air to scour the hollow fibres.

Preferably, the membrane bioreactor comprises a gas supply line extending from the manifold to the air scouring system for delivering air from the manifold to the air scouring system.

Preferably, the membrane bioreactor module comprises a gasket provided between each support and socket to establish and maintain a fluid tight interface therebetween.

Preferably, the gasket comprises a resiliently deformable seal and/or an adhesive seal.

According to a further aspect of the present invention there is provided a fibre membrane assembly for a membrane bioreactor comprising a frame, preferably a rectangular frame, defining at least one enclosure extending between a first face of the frame and an opposed second face of the frame; at least one channel providing fluid communication between the first and second faces; a filtrate enclosure located about the first face of the frame and defining a chamber therein, the channel extending through the filtrate enclosure in isolation from the chamber; and an array of fibre membranes, a free end of each of which is encapsulated within a potting compound filling and sealing the enclosure, wherein a lumen of each fibre membrane is in fluid communication with the chamber.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

The present invention will now be described with reference to the accompanying drawings, in which:

FIG. 1 illustrates a perspective view of a membrane bioreactor module according to a preferred embodiment of the present invention;

FIG. 2 illustrates an enlarged view of an upper assembly of the membrane bioreactor module illustrated in FIG. 1;

FIG. 3 illustrates an enlarged view of a base assembly of the membrane bioreactor module illustrated in FIG. 1;

FIG. 4 illustrates a sectioned view of a corner of the upper assembly of the membrane bioreactor module illustrated in FIG. 2 and showing an internal flow path defined therein; and

FIG. 5 illustrates a sectioned view of a lower corner of the base assembly of the membrane bioreactor module illustrated in FIG. 3 and showing an internal flow path defined therein;

FIG. 6 illustrates a sectioned side elevation across a central portion of the base assembly;

FIG. 7 illustrates a sectioned side elevation across a pair of opposed corners of the base assembly including a respective pair of opposed supports;

FIG. 8 illustrates a plan view from above of a potting frame forming part of the base assembly;

FIG. 9 illustrates a sectioned side elevation of the potting frame of FIG. 10 along line A-A;

FIG. 10 illustrates an enlarged view of detail B in FIG. 11;

FIG. 11 illustrates a plan view, from above, of a filtrate enclosure forming part of the base assembly and which in use is secured to an underside of the potting frame;

FIG. 12 illustrates a sectioned side elevation of the filtrate enclosure of FIG. 11;

FIG. 13 illustrates a plan view of a ring seal provided between a support and the base assembly to provide a fluid tight seal therebetween; and

FIG. 14 illustrates a sectioned view along line A-A of the ring seal shown in FIG. 13.

### DETAILED DESCRIPTION OF THE INVENTION

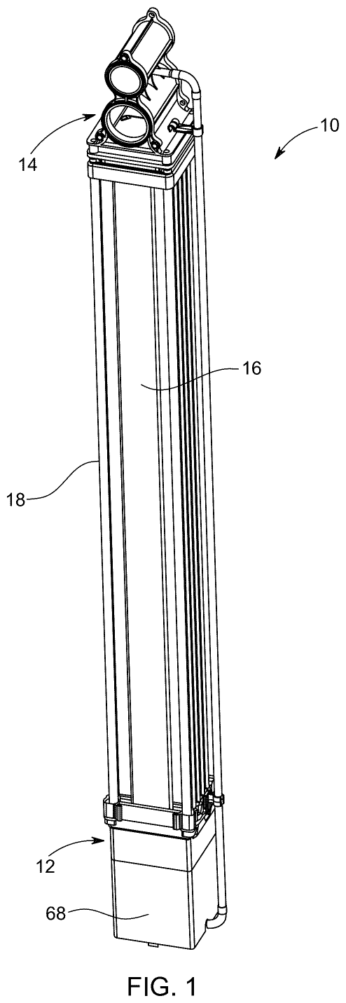

Referring now to the drawings, wherein like reference numerals designate corresponding structure throughout the views, and referring in particular to FIG. 1, there is illustrated a membrane bioreactor module 10 according to a preferred embodiment of the present invention for deployment in a wastewater treatment plant (not shown) or the like, wherein multiple bioreactor modules 10 are arranged in one or more arrays selected to provide the necessary processing/filtration requirements to match the particular hydraulic load. The modules 10 are located in a treatment tank (not shown) and in use are submerged in the wastewater to effect the processing thereof, as is well known in the art and as a result a detailed explanation of the operation thereof is not required. See, for example, The MBR Book and Membrane Systems for Wastewater Treatment, cited above. However unlike the prior art the bioreactor module 10 of the invention provides a novel fluid flow path through the module 10 for permeate which allows the bioreactor module 10 to include a higher fibre density and thus filtration capacity through increased fibre surface area while simultaneously being more easily and cost effectively manufactured and providing increased reliability during operation.

Still referring to FIG. 1, the membrane bioreactor module 10 comprises a base assembly 12, an upper assembly 14 spaced from the base assembly 12 by a suitable distance, and an array of hollow fibre membranes 16 secured between the base and upper assemblies 12, 14 as hereinbefore described. The fibre membranes 16, which may be microfiltration or ultrafiltration membranes, may be of any suitable dimension including length, outer diameter and inner lumen diameter, and may comprise any suitable material, having desired characteristics such as porosity, density, etc. Suitable materials include, without limitation, those described in The MBR Book and Membrane Systems for Wastewater Treatment, cited above, and those set forth in Table 2.3 on p. 71 of Yoon, Seong-Hoon, Membrane Bioreactor Processes—Principles and Applications, Taylor & Francis eBooks (2016), first edition CRC Press (Boca Raton, 2015). Preferred materials include, without limitation, PES, PS, PTFE, HFP, polyolefins (eg PP, PE), PVC, PAN, polyimides, polyamides, and ceramics. PVDF and PVDF blends are more preferred. For example the fibre membranes 16 may comprise polyvinylidene difluoride (PVDF) having a pore size of 0.04um in order to achieve so called ultrafiltration, although any other pore size and/or material may be employed, in particular to suit the intended application of the bioreactor module 10. In an exemplary embodiment the fibre membranes 16 are approximately 1.6 meters in length, with the complete bundle of fibre membranes 16 within such an exemplary bioreactor module 10 defining a surface area of 40m2. In the drawings the fibre membranes 16 are shown schematically in block form representing bundles of individual fibre membranes 16.

As the fibre membranes 16 are typically flexible and thus do not provide any meaningful structural integrity, the bioreactor module 10 comprises at least one, and in the preferred embodiment illustrated four rigid elongate supports 18 extending between the base and upper assemblies 12, 14 in order to fix the assemblies 12, 14 relative to one another. In the preferred embodiment illustrated the bioreactor module 10 has a substantially rectilinear footprint or cross section and includes a support 18 at each corner. It will however be appreciated from the following description of the operation of the invention that alternative configurations may be employed while retaining the novel functionality described herein.

The base and upper assemblies 12, 14 may be formed from any suitable material or combination of materials, and are most preferably moulded from a suitable polymer or the like. Suitable materials include, without limitation, polyamides, ABS, PVC, Acetals, PPO and PPE (such as Noryl™ resins, available from the Sabic Corp. of Saudi Arabia), and PP. Blends of polyamides with inorganic fillers in powder or fiber form, such as glass-filled polyamides, are preferred. Similarly the supports 18 may be formed from any suitable material, such as for example FRP (polyester or vinyl ester), SS, and PVC, and may be appropriately dimensioned to provide the necessary structural strength to the bioreactor module 10. At least one of, and preferably all of the supports 18 are hollow in order to define a fluid flow path therein between the base assembly 12 and the upper assembly 14 in order to allow permeate to be transported from the base assembly 12 to the upper assembly 14 without requiring any additional hardware to provide this flow path. The supports 18 thus serve a dual purpose defining both structural components and fluid distribution pathways. In this way the bioreactor module 10 is operable to extract permeate from the base assembly 12 and optionally also from the upper assembly 14 as will be described.

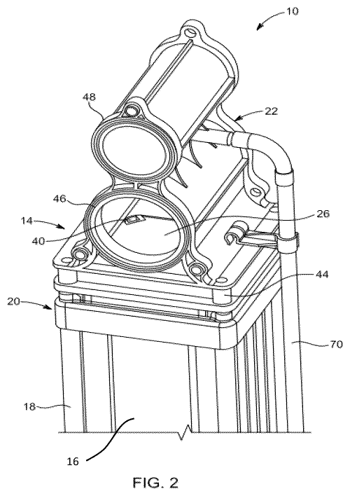

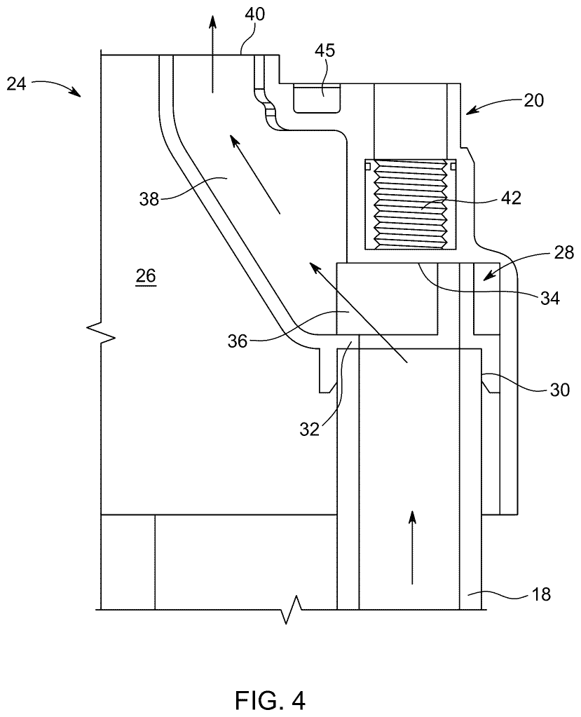

Referring in particular to FIGS. 2 and 4 the upper assembly 14 comprises an anchor plate 20 to which an upper end of the fibre membranes 16 and an upper end of each of the supports 18 is secured. The upper assembly 14 further comprises a manifold 22 mounted in sealing engagement against an upper face of the anchor plate 20 and which is adapted to withdraw permeate from the module 10 and to supply air to the module 10, as described below in further detail. The anchor plate 20 preferably has a substantially rectilinear footprint and defines an enclosure 24 into which, during manufacture, an upper end of each fibre membrane 16 is located and secured, preferably by means of a potting resin 26 which is poured in to fill the enclosure 24 and thus encapsulate the end of each of the fibre membranes 16. The upper end of the fibre membranes 16 may be sealed within the potting resin in order to close the upper end of the fibre membranes 16 whereby permeate can only be drawn from the interior of the fibre membranes 16 into the base assembly 12. Alternatively the upper end of the fibre membranes 16 may be exposed or otherwise in fluid communication with an upper face of the anchor plate 20 as defined by the upper surface of the potting resin 26, thereby allowing fluid flow from within each fibre membrane 16 into the interior enclosure 24 of the manifold 22. This method of securing the fibre membrane 16 is well known in the art, and further detail thereon is not required or relevant to the full understanding of the present invention. It should however be noted that any other functional alternative means of anchoring or securing the fibres 16 to the anchor plate 20 may be employed.

Still referring to FIGS. 2 and 4, each corner of the anchor plate 20 comprises a coupling 28 which functions to secure together the respective support 18, anchor plate 20 and the manifold 22 while establishing a fluid flow path from an interior of the support 18 into an interior of the manifold 22 to allow permeate extraction from the base assembly 12, through the support 18 and into the manifold 22 for removal from the module 10. By providing this fluid flow path through the corner supports 18 there is no requirement for a separate flow path to be provided, thereby reducing complexity and effectively increasing the footprint of the module 10 which can be occupied by the fibre membranes 16, thus increasing the processing capacity of the module 10. The coupling 28 comprises a socket 30 which opens on to a lower face of the anchor plate 20 and which is dimensioned to receive the upper end of the respective support 18. Thus in the case of a cylindrical support 18 as in the illustrated embodiment the socket 30 is of a cylindrical cross section, and having a diameter approximately equal to the outer diameter of the support 18 at least at the upper portion of the socket 30. However the socket 30 may comprise a number of longitudinally extending and radially spaced apart webs or tabs (not shown) which serve to define spaces between the socket 30 and the outer surface of the support 18, into which a suitable adhesive may be applied in order to provide a robust and fluid tight seal therebetween.

The socket 30 also preferably defines at least a partially circumscribing channel 31 adjacent the lower or open end of the socket 30, again into which a sealant and/or adhesive may be applied to further secure and seal the support 18 in place. Thus in use a fluid tight seal is established between the socket 30 and the support 18, which may additionally or alternatively be achieved by means of an interference fit between the parts and/or the provision of the above mentioned suitable sealant or adhesive and/or a gasket or similar hydraulic seal and/or complementary threading on the outer surface of the support 18 and the inner surface of the socket 30 (fluid tight seal not shown).

Still referring to FIGS. 2 and 4, the socket 30 comprises a reduced diameter shoulder 32 towards an upper end of the socket 30 and against which the upper end of the support 18 abuts when fully seated within the socket 30. The socket 30 however extends beyond the shoulder 32 to terminate at a blind upper end 34, although a lateral aperture 36 is provided between the shoulder 32 and the upper end 34. The lateral aperture 36 opens into a duct 38 which extends upwardly to terminate at an outlet 40 located in the upper face of the anchor plate 20, thereby providing a fluid flow path into the interior of the manifold 22.

The duct 38 may be defined by a moulded insert captured within the potting resin 26 although any other suitable alternative formation may be employed, for example moulding the duct 38 integrally with the anchor plate 20. The fluid flow path for permeate as defined by the interior of the support 18 and the duct 38 is illustrated by the arrows provided in FIG. 4.

Still referring to FIGS. 2 and 4, the coupling 28 further comprises a fastener which may take any suitable form, and for example in the embodiment illustrated is in the form of a threaded insert 42 secured to or formed integrally with the anchor plate 20 directly above and axially or longitudinally aligned with the socket 30 and therefore the support 18, but isolated from the socket 30 such that fluid flow into the socket 30 passes entirely into the duct 38 via the lateral aperture 36. The threaded insert 42 is accessible from an upper face of the corner of the anchor plate 20 in order to receive a fastening member such as a bolt (not shown) passed through a corner lug 44 of the manifold 22 so as to secure the manifold 22 in face to face engagement with the upper face of the anchor plate 20. By aligning the threaded insert 42 axially or longitudinally with the support 18 sufficient load bearing capacity is provided by the support 18 to allow the manifold 22 to be clamped tightly against the anchor plate 20 to establish a fluid tight seal therebetween. The threaded insert 42 may be of any suitable material, for example a metal or a polymer having suitable physical characteristics to provide the necessary purchase and retention of the bolt (not shown) or other fastening member.

It will be appreciated that the threaded insert 42 could be omitted and for example a self tapping screw (not shown) could be used to secure the manifold 22 to the anchor plate 20, being screwed directly into the material of the anchor plate 20 at the location of the omitted insert 42. Any other functional alternative may of course be employed, but it has been found that the threaded insert 42 provides a secure, robust and reliable connection. In a preferred arrangement a gasket (not shown) is provided at the interface between the anchor plate 20 and manifold 22 in order to ensure and maintain a fluid tight seal therebetween. A circumscribing channel 45 is provided in the upper face of the anchor plate 20 for receiving and retaining the gasket (not shown). This arrangement provides a robust overall construction to ensure reliability in the relatively harsh operating conditions which the module 10 is likely to be subjected to over the course of the lifetime thereof.

The manifold 22 comprises a fluid permeate conduit 46 which is open to the interior of the manifold 22 and is therefore in direct fluid communication with the upper face of the anchor plate 20, as can be seen for example in FIG. 2, in which one of the outlets 40 can be seen as being in direct communication with the permeate conduit 46. As described above the manifold 22 comprises four corner lugs 44 each with a through aperture to allow the manifold 22 to be bolted or otherwise fastened to the anchor plate 20 and thus to the base assembly 12 via the supports 18. The manifold 22 further comprises an air conduit 48 which is isolated from the permeate conduit 46, the purpose of which is described hereinafter in detail. Any other suitable location or configuration for the air conduit may be employed. The manifold 22 is preferably formed as a single moulding, with the permeate conduit 46 and air conduit 48 thus moulded integrally with one another, although other constructions may equally be utilised.

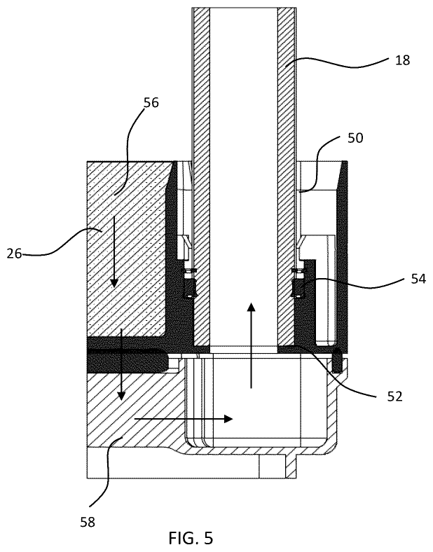

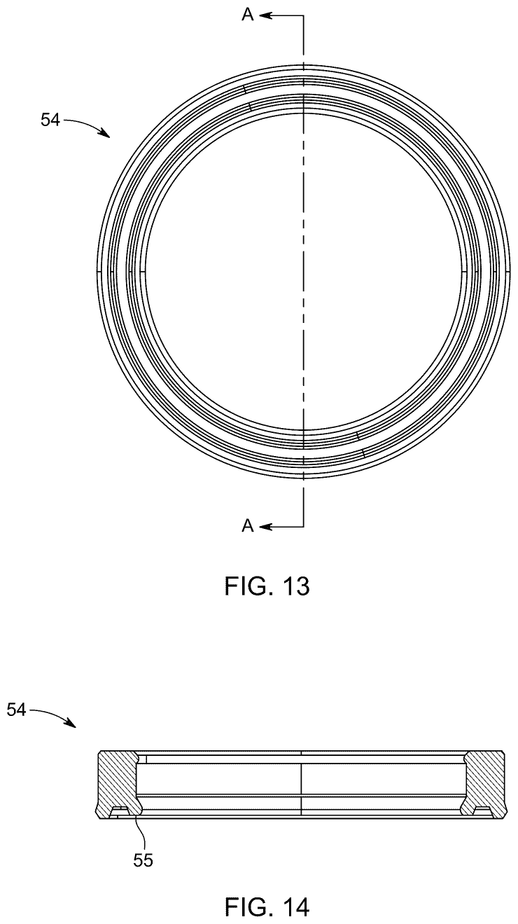

Referring now to FIG. 5 a corner of the base assembly 12 is illustrated in section, revealing the connection between a lower end of the support 18 and the base assembly 12. Each corner of the base assembly 12 defines a socket 50 shaped and dimensioned to receive the support 18, with shoulder 52 of reduced diameter located internally of the socket 50 to provide an abutment against which the end of the support 18 is engaged. While an adhesive or the like is preferably provided between the socket 50 and the support 18, a seal 54 is also preferably provided to ensure that a hydraulic seal is maintained even in the event of a failure of the adhesive. The seal 54 is shown in isolation in FIGS. 13 and 14, and in the preferred embodiment is in the form of a ring seal having a square or rectilinear cross section and preferably having a skirt 55 at a lower end thereof. The use of this particular configuration of seal reduces the force necessary to insert each of the supports 18 into the sockets 50 during manufacture of the bioreactor module 10, allowing all four of the supports 18 to be pressed into the sockets 50 simultaneously. This would not be possible or practical were conventional O-rings employed as the force to compress the rubber O-rings at all four corners would be significant and therefore the frame would become destabilized during the compression. Furthermore, the use of conventional rubber lubricants generally not practical, as these materials typically lead to contamination of the potting resin. It will of course be understood that additional and/or alternative means of sealing the socket 50 and support 18 may be utilised, and for example an adhesive may be provided in the socket 50 to further seal the lower end of the support 18 to the base assembly 12. It will be understood that an additional hydraulic seal may be employed as an alternative or additional means of sealing the support 18 into the upper anchor plate 20 and socket 30 in FIG. 4. Such additional seals are not depicted in FIG. 4. It is further to be understood that the same benefits of the additional seal may also apply to the end of support 18 that is affixed to the upper assembly 14 of the module.

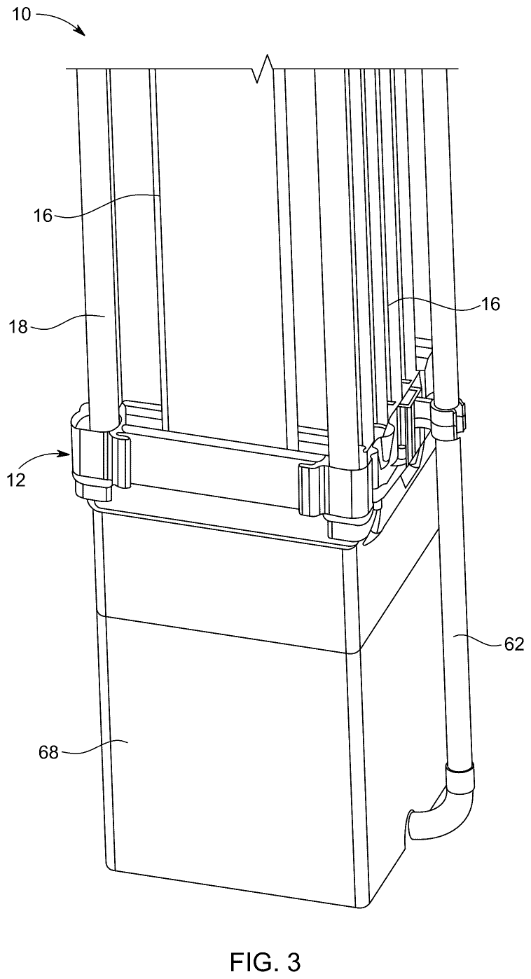

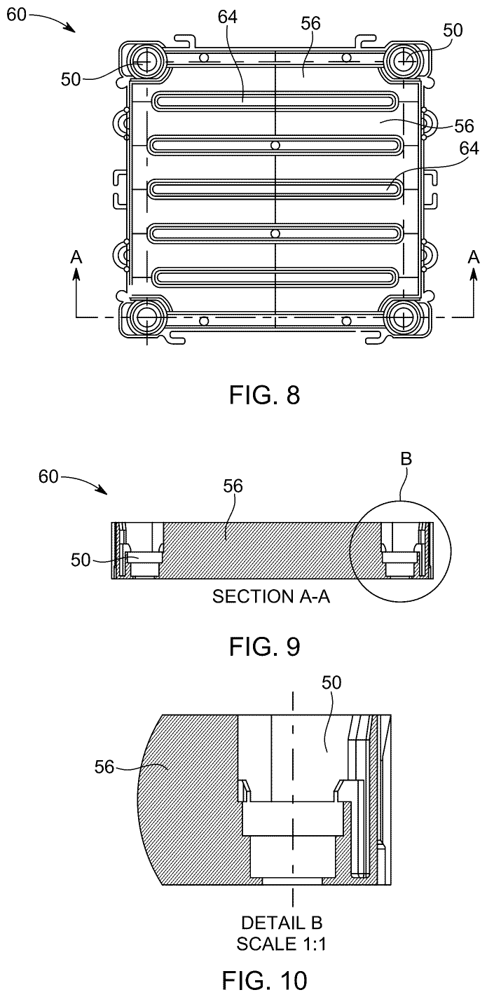

Referring to FIGS. 3 and 5, the base assembly 12 preferably has a substantially rectilinear footprint and defines a slot or enclosure 56. The terms “slot” and “enclosure” are synonymous and used interchangeably herein with respect to feature 56 of the potting frame 60. During manufacture, a lower end of each fibre membrane 16 is located and secured in the slot or enclosure 56, preferably by means of a potting resin (not shown) which is poured in to fill the slot or enclosure 56 and thus encapsulate the lower end of each of the fibre membranes 16. As depicted in FIG. 8, the slots or enclosures 56 may be in fluid communication. Alternatively, each may form a separate closed containment for the potting resin.

A lumen of each of the fibre membranes 16 is in fluid communication with a chamber 58 located directly beneath the enclosure 56. The chamber 58 extends beneath and is in fluid communication with each of the sockets 50. The chamber 58 is otherwise sealed from the exterior of the module 10. Thus permeate drawn into the interior of the fibre membranes 16 can be drawn into the chamber 58, up the interior of the hollow supports 18 and into the permeate conduit 46 defined within the manifold 22 for extraction from the module 10. The fluid flow path for permeate as defined by the chamber 58 and interior of the support 18 is illustrated by the arrows provided in FIG. 5.

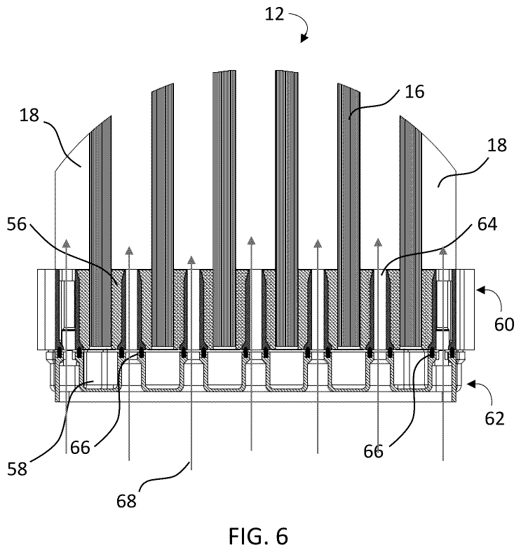

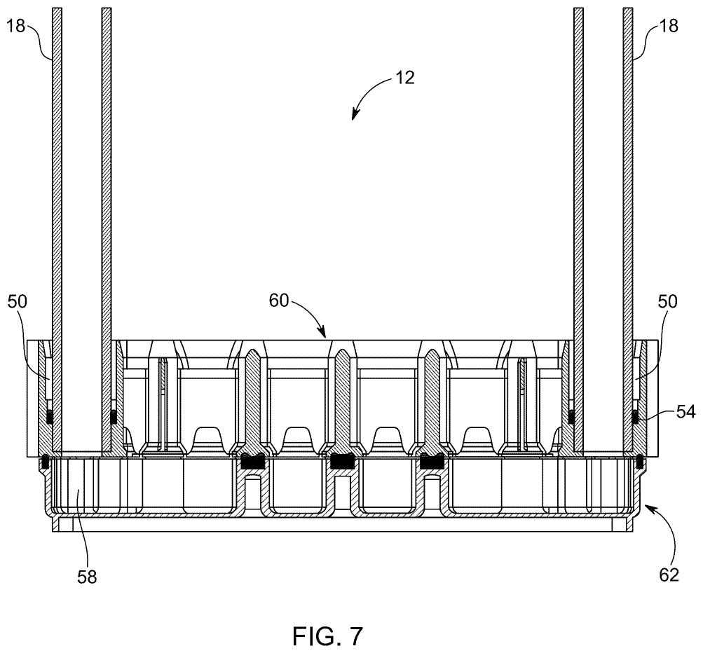

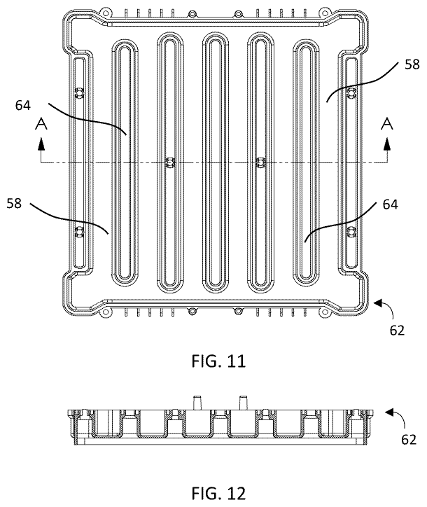

Referring in particular to FIGS. 6 to 12 the base assembly 12 is preferably comprised of a potting frame 60 which defines a plurality of the enclosures 56, and a filtrate enclosure 62 which is secured about and sealed to a lower face of the potting frame 60 such as to fully enclose the lower face thereof and thus define the chamber 58. In the embodiment illustrated six parallel enclosures 56 are provided in the potting frame 60, but the number and configuration thereof may vary. Consequently the chamber 58 within the filtrate enclosure 62 defines six parallel sections corresponding to the enclosures 56, in order to allow filtrate to be drawn out of the open end of each of the fibre membranes 16 into the chamber 58 for transfer through the supports 18. Any suitable means may be employed to secure the filtrate enclosure 62 to the potting frame 60, a fluid tight seal being formed at the interface thereof. The fibre membranes 16 are preferably bundled together in the enclosures 56 and arranged such as to provide space between the enclosures 56, with a number of openings or channels 64 extending upwardly through both the potting frame 60 and the filtrate enclosure 62 of the base assembly 12, in order to allow airflow upwardly through the base assembly 12 as described in detail hereinafter. These openings or channels 64 do not communicate with the interior of the chamber 58 or the enclosures 56 and simply provide a pathway through the base assembly 12 via which scouring air can pass upwardly through the base assembly 12 from an underside thereof to contact the outer surface of the fibre membranes 16. Seals 66 are preferably provided about the interface of the channels 64 to ensure a fluid tight seal at the interface between the potting frame 60 and filtrate enclosure 62. The seals 66 may be formed integrally with the potting frame 60 and/or filtrate enclosure 62, for example by means of over moulding. Alternatively, other suitable means of sealing, such as gaskets, may be employed.

The fibre membranes 16 are secured within each of the enclosures 56 with potting resin or functional equivalent which fills the space between the fibre membranes 16 and thus forms a seal around each of the fibre membranes 16 and between the sidewalls of the enclosure 56, thereby preventing fluid flow though the enclosures 56 other than through the lumen of each of the fibre membranes 16. The fibre membranes 16 extend from the enclosures 56 up to the upper assembly 14. The lower free end of each of the fibre membranes 16 is open to the lower face of the potting frame 60 and is thus in communication with the chamber 58 within the filtrate enclosure 62. In this way filtrate can be drawn from the fibre membranes 16 into the chamber 58. Although the chamber 58 is divided into sections corresponding to the enclosures 56 of the potting frame 60, the sections are preferably in fluid communication with one another, and each corner of the chamber 58 is in fluid communication with the lower free end of the respective support 18.

In a preferred method of manufacture, bundles of the fibre membranes 16 are inserted within each of the enclosures 56, with one free end of each of the fibre membranes 16 protruding out of the underside of the enclosure 56 a short distance beyond the lower face of the potting frame 60. The enclosures 56 are then filled with potting resin or the like in order to bond the fibre membranes 16 to the potting frame 60. The potting resin is also allowed to extend beyond the lower face of the potting frame 60 to encapsulate the protruding fibre membranes 16. Once the potting resin has cured the excess extending beyond the lower face of the potting frame 60 is removed by any suitable means, preferably in a single cutting or slicing step, such that the potting resin is left flush with or protruding slightly from the lower face of the potting frame 60. For example it may be preferably to leave 1-3 mm of potting resin protruding from the lower face of the potting frame 60 in order to avoid potential damage during the cutting step. The outer perimeter of the protruding resin may be reduced or stepped down in size in order to be accommodated within the filtrate enclosure 62. The short length of each of the fibre membranes 16 projecting beyond the lower face of the potting frame 60 is therefore also removed. This step results in the inner lumen of each of the fibre membranes 16 being open to the lower face of the potting frame 60, in order to establish a flow path from the lumen of each of the fibre membranes 16, in use, into the chamber 58. The removal of the excess potting resin also generates a smooth finish on the surface which may allow a fluid tight seal with the filtrate enclosure 62 to be established and maintained during operation, although the flat surface of the potting frame 60 may also provide this sealing function.

In addition, a mechanical securing device may be employed to secure the supports 18 to the socket 50 in the lower potting frame 60. This device may provide security to the connection of the supports to the potting frame in addition to that provided by the resin adhesion. The benefit of a mechanical fastening device is that it secures the supports as soon as they are inserted into the potting frame. The potting resin may also provide enough security however the resin takes time after injecting to set and build up strength particularly as the amount of resin bonding the supports to the base is small so the resin quickly loses exothermic heat of reaction that would otherwise speed up the curing reaction. The time taken to build up sufficient “green” adhesion strength of the resin between the supports and the potting frame adds to the production cycle time, adds to product costs and reduces production capacity. The securing device is depicted as a retaining ring that engages a groove in the support 18 and a feature in the potting frame 60 as in FIG. 5. By preference the device is a retaining ring or gripper but other mechanical fastening devices could be employed such as a pin or threaded fastener engaging both the potting frame and the support. The securing device might also be pre-assembled into an insertable sub assembly that includes the seal 54. Such sub assembly might be inserted into potting frame prior to the potting process.

Referring now to FIGS. 1, 2 and 3 the membrane bioreactor module 10 preferably also comprises an air scouring system 68 mounted beneath the base assembly 12 and which in use is supplied with air from the air conduit 48 of the manifold 22 via a gas supply line 70. The air scouring system 68 is operable in known manner to generate relatively large pulses or plugs of air which travel upwardly through the above described openings or channels 64 (depicted in FIG. 6) provided in the base assembly 12 to scour the fibre membranes 16 so as to effect removal of solids adhered thereto. Examples of such an air pulsed air scouring system are commercially available from DuPont Water Solutions of Wilmington, DE, U.S.A., under the trademark MemPulse® Membrane Bioreactor (MBR) Systems, and are for example described in European Patent EP2152390B1 which discloses a membrane bioreactor module including an air scouring system, where the scouring system is mounted below the membrane bioreactor module in a manner generally similar to air scouring system 68 in the module 10 of the present invention.

The scouring system 68 introduces air at the base of the membrane module 10 in the form of large bubbles or slugs that increase in size as they move up the length of the fibre membranes 16 of the membrane module 10. The size and the focused nature of the large slugs of air prevent trash and solids build up by pushing debris away from the surface of the membrane fibre membranes 16. At the same time the large aeration pulse creates an airlift flow that draws mixed liquor into the bottom of each membrane module 10 via inlets connected to enclosure 56 and chamber 58. The air bubbles then blend with the mixed liquor and pass through the openings (not shown) in the base assembly 12 to rise upwardly between the individual membrane fibre membranes 16 via channels 64. This creates a unique crossflow pattern, providing an even distribution of mixed liquor and a reduction of solids concentration on the surface of the fibre membranes 16. Arrows 68 show the pathways of the air bubbles through the base assembly 12.

In summary, provided herein is an improved bioreactor module 10 in which permeate filtered by the membrane fibre membranes 16 can be drawn downwardly into the base assembly 12 and from there drawn up into the upper assembly 14 via one or more corner supports 18. This allows permeate to be extracted from the lower end of each of the membrane fibre membranes 16 and optionally also from the upper end directly into the permeate conduit 46. The corner supports 18 constitute a structural component of the module 10 while simultaneously defining a fluid flow path for permeate between the base assembly 12 and the upper assembly 14. This reduces the part count and thus cost and complexity of manufacture, by ensuring that no further fluid flow paths are required. In addition the absence of additional dedicated flow paths maximises the surface area of both the base and upper assemblies 12, 14 which is available for the provision of the fibre membranes 16. Thus a greater density of fibre membranes 16 is achieved, allowing greater filtration capacity for each module 10.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A membrane bioreactor module comprising a base assembly, an upper assembly, and an array of hollow fibre membranes extending therebetween; a plurality of support members extending between the base assembly and the upper assembly, at least one of the support members being hollow and defining a fluid flow path between the base and upper assemblies; wherein the upper assembly comprises an anchor plate having an upper face and a lower face and into which lower face one end of each of the support members is fixed; a plurality of couplings in the anchor plate each defining a socket open to the lower face and retaining an end of the respective hollow support member; and at least one duct extending from the socket and opening onto the upper face.

2. A membrane bioreactor module according to claim 1 in which the anchor plate defines at least one enclosure filled with a potting resin securing the hollow fibre membranes to the anchor plate.

3. A membrane bioreactor module according to claim 2 in which each duct extends through the potting resin; or in which the potting resin constitutes the upper face of the anchor plate; or further comprising one fastener for each duct, wherein each duct opens onto the upper face adjacent to its respective fastener.

4. (canceled)

5. (canceled)

6. A membrane bioreactor module according to claim 1, in which each duct terminates in an insert secured to the anchor plate.

7. A membrane bioreactor module according to claim 1, in which the socket is integrally formed with the anchor plate.

8. A membrane bioreactor module according to claim 1, in which the socket defines an open lower end, a closed upper end, and a lateral window from which the duct extends.

9. A membrane bioreactor module according to claim 1, in which the hollow support member is adhered into the socket.

10. A membrane bioreactor module according to claim 1, in which the hollow support member is adhered into the base assembly.

11. A membrane bioreactor according to claim 1, comprising a manifold mounted to the upper face of the anchor plate for establishing fluid communication with the bioreactor module.

12. A membrane bioreactor module according to claim 11 in which each coupling comprises a fastener axially aligned with the socket and accessible at the upper face for securing the manifold to the anchor plate.

13. A membrane bioreactor module according to claim 12 in which the fastener comprises a threaded insert secured to the anchor plate and having a thread with a longitudinal axis co axial with a longitudinal axis of the support member and the socket.

14. A membrane bioreactor module according to claim 12 in which the manifold is bolted to the anchor plate; or in which the membrane bioreactor further comprises a gasket captured between the manifold and the anchor plate.

15. A membrane bioreactor module according to claim 12 in which the manifold comprises a respective lug having a through aperture which overlies each fastener when the manifold is aligned against the upper face of the anchor plate.

16. A membrane bioreactor module according to claim 12 in which the manifold defines a fluid permeate conduit in fluid communication with the at least one duct, a separate air supply conduit for delivering air to the base assembly, or both a fluid permeate conduit in fluid communication with the at least one duct, a separate air supply conduit for delivering air to the base assembly.

17. (canceled)

18. A membrane bioreactor module according to claim 1, which is substantially rectangular in cross section, four support members being provided, one at each corner; or in which more than one of the support members is hollow and defines a respective fluid flow path between the base and upper assemblies; or in which the base assembly comprises at least one enclosure filled with potting resin securing the hollow fibre membranes to the base assembly in a manner which permits fluid communication between a lumen of each fibre and a chamber of the base assembly.

19. (canceled)

20. (canceled)

21. A membrane bioreactor module according to claim 20 comprising a plurality of enclosures, adjacent enclosures being separated from one another by a channel which extends through the base assembly.

22. A membrane bioreactor module according to claim 1, comprising an air scouring system mounted to the base assembly.

23. A membrane bioreactor module according to claim 22 in which the air scouring system is operable to generate pulsed release of air to scour the hollow fibre membranes; or wherein the bioreactor module further comprises a gas supply line extending from the manifold to the air scouring system for delivering air from the manifold to the air scouring system.

24. (canceled)

25. A membrane bioreactor module according to claim 1, comprising a seal provided between each support and socket to establish and maintain a fluid tight interface therebetween.

26. A membrane bioreactor module according to claim 25 in which the seal comprises a resiliently deformable seal and/or an adhesive seal.
